(19) United States
(12) Patent Application Publication
(10) Pub. No.: US 2024/0049250 A1
(43) Pub. Date: Feb. 8, 2024

(54) UPLINK CONTROL SIGNALING FOR PDCCH MONITORING

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/356,108

(22) Filed: Jul. 20, 2023

Related U.S. Application Data
(60) Provisional application No. 63/394,437, filed on Aug. 2, 2022.

(51) Int. Cl. H04W 72/232; H04W 72/21

(52) U.S. Cl. CPC H04W 72/232; H04W 72/21

(57) ABSTRACT

Methods and apparatuses for uplink control signaling for physical downlink control channel (PDCCH) monitoring in a wireless communication system. A method includes receiving first information for a set of operation states for a cell and second information for a set of resources for physical uplink control channel (PUCCH) transmissions. The method further includes determining, at a first time, first one or more operation states, from the set of operation states, for the cell and a resource from the set of resources based on the first one or more operation states for the cell. The method further includes transmitting, in response to the determination at the first time, a first PUCCH using the resource.

### CROSS-REFERENCE TO RELATED APPLICATIONS AND CLAIM OF PRIORITY

The present application claims priority to U.S. Provisional Patent Application No. 63/394,437, filed on Aug. 2, 2022. The contents of the above-identified patent documents are incorporated herein by reference.

### TECHNICAL FIELD

The present disclosure relates generally to wireless communication systems and, more specifically, the present disclosure relates to an uplink control signaling for physical downlink control channel (PDCCH) monitoring in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an uplink control signaling for PDCCH monitoring in a wireless communication system.

In one embodiment, a user equipment (UE) is provided. The UE includes a transceiver configured to receive first information for a set of operation states for a cell and second information for a set of resources for physical uplink control channel (PUCCH) transmissions. The UE further includes a processor operably coupled to the transceiver. The processor is configured to determine, at a first time, first one or more operation states, from the set of operation states, for the cell and a resource from the set of resources based on the first one or more operation states for the cell. The transceiver is further configured to transmit, in response to the determination at the first time, a first PUCCH using the resource.

In another embodiment, a base station (BS) is provided. The BS includes a transceiver configured to transmit first information for a set of operation states for a cell and second information for a set of resources for PUCCH receptions. The BS further includes a processor operably coupled to the transceiver. The processor is configured to determine, at a first time, first one or more operation states, from the set of operation states, for the cell, and a resource from the set of resources based on the first one or more operation states for the cell. The transceiver is further configured to receive, in response to the determination at the first time, a first PUCCH using the resource.

In yet another embodiment, a method is provided. The method includes receiving first information for a set of operation states for a cell and second information for a set of resources for PUCCH transmissions. The method further includes determining, at a first time, first one or more operation states, from the set of operation states, for the cell and a resource from the set of resources based on the first one or more operation states for the cell. The method further includes transmitting, in response to the determination at the first time, a first PUCCH using the resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates a flowchart of UE procedure to select a PUCCH resource and transmit a PUCCH with STR information according to embodiments of the present disclosure;

FIG. 7 illustrates a flowchart of UE procedure to transmit a PUCCH indicating STR information and to monitor PDCCH for scheduling PDSCH receptions or PUSCH transmission according to embodiments of the present disclosure;

FIG. 8 illustrates example of timing relationships for a PUCCH transmission with STR information and PDCCH monitoring occasions according to this disclosure;

FIG. 9 illustrates a flowchart of UE procedure to start monitoring PDCCHs for scheduling PDSCH receptions or PUSCH transmissions after T_1 slots from a slot of a PUCCH transmission indicating STR information according to embodiments of the present disclosure;

FIG. 10 illustrates a flowchart of UE procedure to start monitoring PDCCHs for scheduling PDSCH receptions or PUSCH transmissions after T_1 slots from a slot of a PDCCH reception with DCI format 2_8 according to embodiments of the present disclosure;

FIG. 11 illustrates a flowchart of UE procedure to stop monitoring PDCCHs for scheduling PDSCH receptions or PUSCH transmissions (or for DCI format 2_8), after the UE has not detected any DCI format that schedules PDSCH receptions or PUSCH transmissions (or the DCI format 2_8) after T_2 slots from a slot of a PUCCH transmission indicating STR information according to embodiments of the present disclosure;

FIG. 12 illustrates a flowchart of UE procedure to start monitoring PDCCHs for detection of DCI format 2_8 at a first PDCCH monitoring occasion after T_(1\hat{ }′) slots from a slot of a PUCCH transmission indicating STR information according to embodiments of the present disclosure; and

FIG. 13 illustrates a flowchart of UE procedure to retransmit a PUCCH with STR information and monitor PDCCHs when the UE stops monitoring PDCCHs prior to the PUCCH retransmission according to embodiments of the present disclosure.

### DETAILED DESCRIPTION

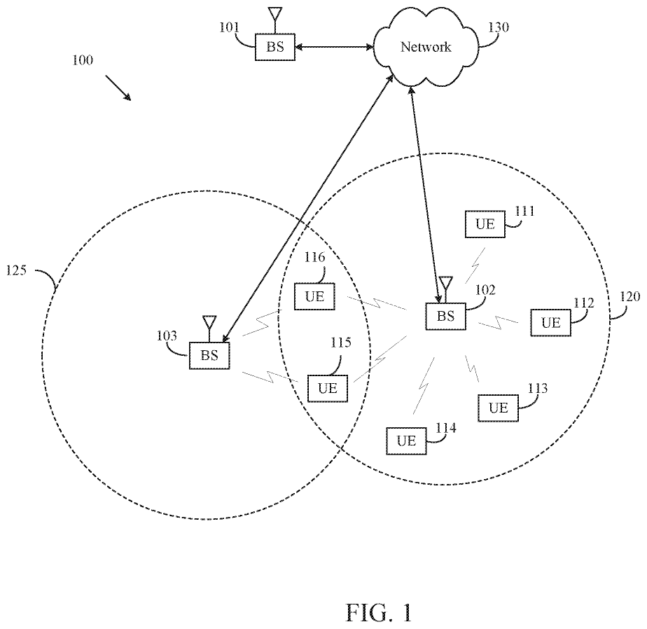

FIG. 1 through FIG. 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.2.0, “NR; Physical channels and modulation”; 3GPP TS 38.212 v17.2.0, “NR; Multiplexing and Channel coding”; 3GPP TS 38.213 v17.2.0, “NR; Physical Layer Procedures for Control”; 3GPP TS 38.214 v17.2.0, “NR; Physical Layer Procedures for Data”; 3GPP TS 38.321 v17.1.0, “NR; Medium Access Control (MAC) protocol specification” and 3GPP TS 38.331 v17.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for uplink control signaling for PDCCH monitoring in a wireless communication system. In certain embodiments, and one or more of the gNBs 101-103 includes circuitry, programing, or a combination thereof, to support uplink control signaling for PDCCH monitoring in a wireless communication system.

Although FIG. 1 illustrates one example of a wireless network, various changes may be made to FIG. 1. For example, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

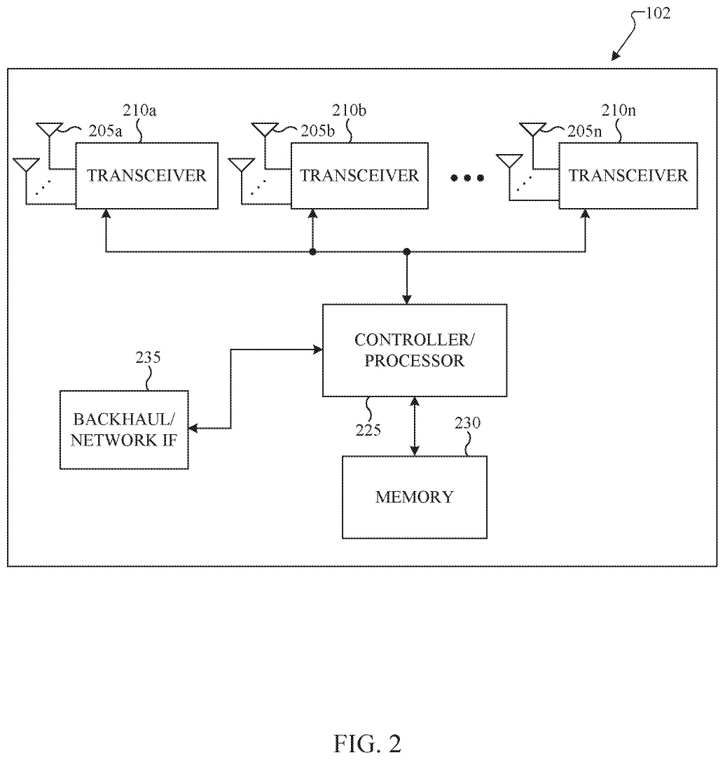

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support uplink control signaling for PDCCH monitoring in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

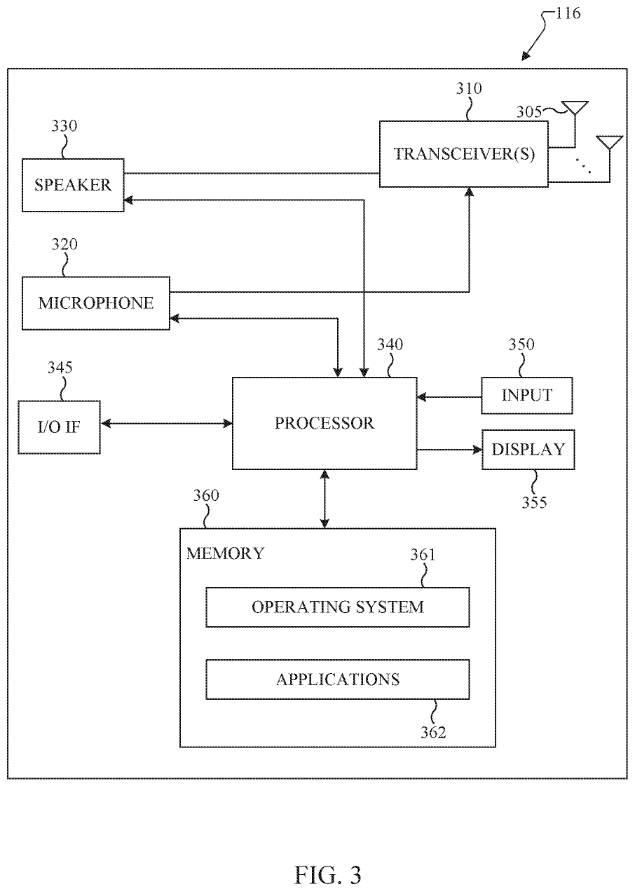

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for uplink control signaling for PDCCH monitoring in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

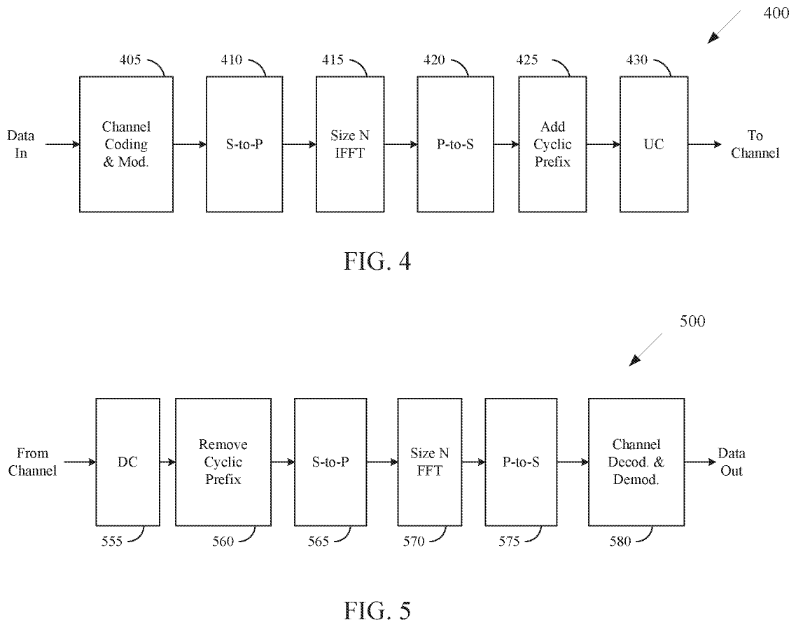

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support uplink control signaling for PDCCH monitoring in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can assume use of a same DM-RS precoder, a number of consecutive symbols for the CORESET, a set of resource blocks (RBs) for the CORESET, CCE-to-REG mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a CSS set or a USS set. When search space set s is a CSS set, the UE monitors PDCCH for detection of DCI format 2_x, where x ranges from 0 to 7 as described in TS 38.212, or for DCI formats associated with scheduling broadcast/multicast PDSCH receptions, and possibly for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ)mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 and TS 38.214.

Network energy savings is becoming a performance indicator of greater importance for networks as the energy cost represents a substantial portion of the overall operating cost while an increasing demand for applications with higher data rates requires the use of more antennas and bands which in turn requires a higher energy consumption and has a larger environmental impact. To reduce energy consumption, a network should be able to adapt operation according to traffic conditions and operate in different network energy saving (NES) modes or network (NW) operation states on a cell. A NW operation state may include one or more operation states on respective one or more groups of cells of the NW. A group of cells includes one or more cells.

In one example, in absence of UL/DL traffic, a network can reduce operation in time/frequency/spatial/power domains to a minimal one necessary for UEs to maintain an RRC connection to a serving gNB while in presence of UL/DL traffic, the NW can change a NW operation state on a cell to one corresponding to the traffic characteristics. Thus, the network can operate in various operating states, for example according to considerations for NW energy savings and for servicing required traffic. In another example the network can use a number of NW operation states, and different NW operation states on a cell, or simply different states, or operation states, for the network can be associated to transmission of specific signaling or to monitoring/reception of specific signaling by a serving gNB or by a UE, or can be associated to specific characteristics of transmissions and/or receptions, such as a periodicity or a transmit power.

For example, a first NW operation state on a cell can correspond to use of all/most resources in one or more of time/frequency/spatial/power domains by a serving gNB, a second NW operation state on a cell can correspond to minimal or no use of any such resources while intermediate states can correspond to reduced utilization of most such resources such as for example, support of transmissions or receptions of only a subset of possible signals/channels or support of transmissions/receptions only in non-consecutive time intervals or only in a bandwidth that is smaller than a maximum bandwidth.

Present networks have limited capability to adapt an operation state in one or more of time/frequency/spatial/power domains. For example, in NR, there are transmissions or receptions by a serving gNB that are expected by UEs, such as transmissions of SS/PB CH blocks or system information or of CSI-RS indicated by higher layers, or receptions of PRACH or SRS indicated by higher layers. Reconfiguration of a NW operation state involves higher layer signaling by a SIB or by UE-specific RRC. That is a slow process and requires substantial signaling overhead, particularly for UE-specific RRC signaling.

For example, it is currently not practical or possible for a network in typical deployments to enter an energy saving state where the network does not transmit or receive due to low traffic as, in order to obtain material energy savings, the network needs to suspend transmissions or receptions for several tens of milliseconds and preferably for even longer time periods. A similar inability exists for suspending transmission or receptions for shorter time periods as a serving gNB may need to transmit SS/PBCH blocks every 5 msec and, in TDD systems with UL-DL configurations having few UL symbols in a period, the serving gNB may need to receive PRACH or SRS in most UL symbols in a period.

In present NWs, adaptation of a NW operation state on a cell is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality may be limited or none, is currently limited as there are no procedures for a serving gNB to perform fast adaptation of a NW operation state, with small signaling overhead, while simultaneously informing all UEs.

The general principle for adaptation of NW operation states on a cell by physical layer signaling includes a serving gNB indicating to a UE a set of NW operation states on the cell by higher layer signaling, such as by a SIB or UE-specific RRC signaling, and transmitting a PDCCH that provides a DCI format, referred to as DCI format 2_8 in the disclosure, indicating one or more indexes to the set of NW operation states on the cell for the UE to determine an update of NW operation states on the cell. A NW operation state may include one or more operation states on respective one or more groups of cells of the NW. A group of cells includes one or more cells.

For example, in a power domain, a first NW operation state on a cell can be associated with a first value of parameter ss-PBCH-BlockPower providing an average energy per resource element (EPRE) with secondary synchronization signals (SSS) in dBm, and a second NW operation state on the cell can be associated with a second value of a parameter ss-PBCH-BlockPower. For example, first and second NW operation states on the cell can be respectively associated with first and second values of parameter powerControlOffsetSS that provides a power offset (in dB) of non-zero power (NZP) CSI-RS RE to SSS RE.

For example, in a frequency domain, first and second NW operation states on a cell can be respectively associated with first and second values of a parameter locationAndBandwidth that indicates a frequency domain location and a bandwidth for receptions or transmissions by UEs.

For example, in a spatial domain, first and second NW operation states on the cell can be respectively associated with first and second values of a parameter maxMIMO-Layers that indicates a maximum number of MIMO layers to be used for PDSCH receptions by a UE in the associated active DL BWP, or with first and second values of a parameter nrOfAntennaPorts that indicates a number of antenna ports to be used for codebook determination for PDSCH receptions, or with first and second values of a parameter active CoresetPoolIndex that coresetPoolIndex values for PDCCH transmissions in corresponding CORESETs and UEs can skip PDCCH receptions in a CORESET with coresetPoolIndex value that is not indicated by active CoresetPoolIndex.

For example, in a time domain, first and second NW operation states on a cell can be respectively associated with first and second values of a parameter ssb-PeriodicityServingCell that indicates a transmission periodicity in milliseconds for SS/PBCH blocks, or with first and second values of a parameter ssb-PositionsInBurst that indicates time domain positions of SS/PBCH blocks in a SS/PBCH block transmission burst, or with first and second values of a parameter groupPresence that indicates groups of SS/PBCH blocks, such as groups of four SS/PBCH blocks with consecutive indexes, that are transmitted.

A serving gNB can provide a UE one or more search space sets to monitor PDCCH for detection of a DCI format 2_8 that indicates NW operation states on a cell as described in the subsequent embodiments of the disclosure. The search space sets for DCI format 2_8 can be separate from other search space sets for other DCI formats that the serving gNB provides to the UE or some or all search space sets can be common and the UE can monitor PDCCH for the detection of both the DCI format 2_8 that indicates NW operation states on the cell and for other DCI formats providing information for scheduling PDSCH receptions or PUSCH transmissions or SRS transmissions, or providing other control information for the UE to adjust parameters related to transmissions or receptions. The search space sets can be CSS sets or USS sets. When the search space sets are CSS sets, a serving gNB can indicate the search space sets associated with DCI format 2_8 through higher layer signaling in a SIB or through UE-specific RRC signaling. A UE can monitor PDCCH for detection of DCI format 2_8 both in the RRC_CONNECTED state and in the RRC_INACTIVE state according to the corresponding search space sets and DRX operation may not apply for PDCCH receptions that provide DCI format 2_8.

A UE can receive PDCCHs providing DCI format 2_8 in an active DL BWP. Alternatively, a UE can receive PDCCHs providing DCI format 2_8 in an initial DL BWP that was used by all UEs to perform initial access and establish RRC connection with a serving gNB. The latter option enables a single PDCCH transmission with DCI format 2_8 from the serving gNB to all UEs because the initial DL BWP is common to all UEs, while the former option avoids a BWP switching delay because a UE receives PDCCHs providing DCI format 2_8 in the active DL BWP. It is also possible that the serving gNB indicates the DL BWP for PDCCH receptions that provide DCI format 2_8 through higher layer signaling, for example in a SIB.

A UE can request a transition from one network operating state to another operating state. For example, when a network operates in a state where the network does not receive and a UE has data to transmit, the UE can send a state transition request (STR) signal to the gNB requesting the gNB to transition to an operating state where the UE can obtain service such as to be scheduled PUSCH transmissions. If a signal/channel transmission providing STR information by a UE is only supported when a serving gNB operates in a sleep state, that is a state without using time/frequency/spatial/power resources, the STR may also be referred to as a UE-initiated wake-up-signal (WUS) for the gNB. In such cases, the STR may also be provided through a physical random access channel (PRACH).

In a simplest form, an STR signal transmission can be based on on-off keying modulation where a transmission indicates a request to a NW operation state transition and absence of transmission indicates no such request. For example, an STR can be provided by a PUCCH transmission similar to a scheduling request (SR) or similar to a PRACH as described in TS 38.211 and TS 38.213. However, in some cases, such information can be inadequate as a serving gNB cannot know service requirements for the type of traffic for a UE transmitting the PUCCH with the STR and does not know an appropriate operation state to transition to. For example, if the UE traffic can be served by CG-PUSCH transmissions from the UE and does not require low latency, the serving gNB may initially transition to a state supporting only receptions and, if retransmissions of transport blocks (TBs) are needed due to previous incorrect receptions of the TBs, the first transition to a first NW operation state that supports only receptions can be followed at a later time by a second transition to a second NW operation state that supports both receptions and transmissions of PDCCHs that provide DCI formats to schedule PUSCH transmissions for the UE to again provide the incorrectly received TBs.

For example, if the UE traffic requires low latency or it cannot be served by CG-PUSCH transmissions, the NW can directly transition to a NW operation state that supports both transmissions, such as for PDCCHs providing DCI formats for scheduling PUSCH transmissions from the UE, and receptions. Further, it is possible that a UE may need to receive from, instead of transmit to, the serving gNB, for example in order to maintain time-frequency synchronization or perform measurements and maintain an RRC connection with the serving gNB, or to establish RRC connection with the gNB due to mobility. In such case, the UE may indicate a NW operation state that includes transmission of SS/PBCH blocks or of reference signals from the serving gNB.

To improve network energy savings, it is beneficial to align a transmission of a channel such as a PUCCH or a PRACH, or of a signal, providing STR among UEs. Such alignment can enable a serving gNB to operate in a low energy state for a longer time period as the serving gNB does not need to receive channels or signals from UEs at different times and the channels/signals receptions for STR can be received by all associated UEs at a same time interval. Further, in order to minimize a time between transmissions of channels/signals providing STR and transmissions of PDCCHs providing a DCI format 2_8 that indicates a NW operating state, it is beneficial to define a time relation between those two types of transmissions. For example, channels/signals providing STR can be transmitted from UEs during a time interval, such as a slot, that can be indicated or can be determined with respect to an indicated time interval for a monitoring occasion of a PDCCH providing a DCI format 2_8 that indicates NW operation states on a cell.

Therefore, there is a need to define a procedure for enabling a UE to transmit a signal/channel providing a STR to a serving gNB.

There is another need to define a channel/signal providing a STR that enables a serving gNB to determine a NW operation state on a cell for a transition, including to maintain a current NW operation state on the cell.

There is another need to determine resources for a channel/signal providing STR that are common to UEs of a serving gNB.

Finally, there is another need to determine a time relation between a time interval of a channel/signal transmission that provides STR and a PDCCH reception that provides a DCI format indicating a NW operation state on a cell.

Throughout the disclosure, a NW operation state on a cell is also referred to as a NW operation mode or NW operation configuration. The terms “NW operation state”, “NW operation mode”, or “NW operation configuration” are used interchangeably in this disclosure to refer to a network operation that may be dynamically adapted in order to save energy and/or based on the traffic types and load, so that the network may operate in more than one state. A NW operation state may include one or more operation states on respective one or more groups of cells of the NW. A group of cells includes one or more cells.

The following embodiments consider that a UE provides STR information to a serving gNB through a PUCCH transmission. The embodiments are also applicable in case the UE provides STR information to a serving gNB through a signal transmission, such as by using a sequence with specific parameters, for example as for SRS transmission.

A UE can be provided by a serving gNB a set of NW operation states on a cell where each of the states corresponds to a configuration for transmissions and receptions by the serving gNB in one or more of time/frequency/spatial/power domains. The serving gNB can provide the set of NW operation states on the cell via higher layer signaling, such as in a system information block (SIB) or by UE-specific RRC signaling. The UE can also be provided resources for PUCCH transmissions providing STR information that indicates a NW operation state on a cell and may also additionally provide information about a purpose of service for the UE, such as traffic characteristics at the UE or need for measurements by the UE. For example, the traffic characteristics may relate to latency requirements or may be an indication for a buffer status at the UE, and the need for measurements may relate to providing mobility support for the UE.

The UE can be indicated by a serving gNB by higher layers to provide STR information for a subset of the set of NW operation states on a cell, including for the full set of NW operation states on the cell. The UE can additionally be indicated by the serving gNB to provide STR information for a purpose that the UE needs to use a NW operation state on the cell that the UE indicates via the STR information, for example for whether or not the UE needs to transmit data and a corresponding latency requirement, such as latency-tolerant or latency-sensitive data, or for whether the UE requires mobility support, and so on.

In one example, a UE can provide STR information through resource selection for a corresponding PUCCH transmission. In order for the UE to provide N bits of STR information, the UE needs to be provided 2^{N} PUCCH resources to select from for a PUCCH transmission. Those resources can be common among UEs and be provided by a SIB or by UE-specific RRC signaling. The UE can transmit a PUCCH using PUCCH format 0 or PUCCH format 1 without applying a modulation (e.g., as an unmodulated sequence). For example, to indicate one of four NW operation states on a cell and additionally indicate data arrival for latency-tolerant or latency-sensitive, the UE can be provided 8 PUCCH resources to indicate respective 3 bits of information. For example, to only indicate data arrival, the UE can be provided 1 PUCCH resource and a serving gNB can determine a NW operation state based on such STR information (and STR information from other UEs), for example, the serving gNB can determine a NW operation state supporting receptions by the serving gNB.

Different PUCCH resources can also be associated with different parameters for determining a PUCCH transmission power, as described in TS 38.213, as different STR information may need to have different reception reliability. For example, STR information indicating to a serving gNB to adapt a NW operation state on a cell from one with higher utilization of time/frequency/spatial/power resources to one with lower utilization may have a smaller reliability requirement than STR information indicating the reverse. For example, STR information indicating to the serving gNB that the UE has data to transmit may require larger reception reliability when the data is latency-sensitive than when the data is latency-tolerant.

A determination of a power for the PUCCH transmission, for example as described in TS 38.213, may exclude a closed-loop power control component that is based on accumulation of TPC commands because a UE may not have transmitted or received for a time period that is longer than a time period required for materially correlated short term channel fading characteristics and a value of the closed-loop power control component may then be outdated. Alternatively, a UE can be provided by higher layers a time period, for example in slots of the active BWP or in slot of a reference numerology or in absolute time such as milliseconds, where the UE sets to 0 the value of the closed loop power control component if the UE has not received any TPC commands or if the UE did not transmit during the time period.

In one example, a UE can provide STR information through a PUCCH transmission that includes information bits. If the number of information bits is not larger than 2, a serving gNB can provide to the UE a PUCCH resource, associated for example with PUCCH format 1, for the UE to use for a PUCCH transmission providing STR information. If the number of information bits is larger than 2, the serving gNB can provide to the UE a PUCCH resource, associated for example with PUCCH format 2, 3, or 4, for the UE to use for a PUCCH transmission providing STR information.

In one example, a UE can provide STR information together with other UCI, such as a CSI report or a SR, in a PUCCH or a PUSCH transmission, thereby introducing STR information as a new UCI type. Alternatively, the UE can provide STR information by higher layers, such as a MAC control element (CE), in a PUSCH transmission. For example, a new MAC CE can be defined for STR information where the UE can indicate a preferred NW operation state.

The above approaches can also be combined where, for example, when a NW operation state on a cell corresponds to minimal/no use of time/frequency/spatial/power resources, such as a “sleep” state for the NW, the first approach or the second approach can be used; otherwise, the third approach can be used. For example, the first approach can be used for a UE to indicate/request to a serving gNB to transition to a NW operation state where scheduling for the UE or measurements by the UE can be supported while the second or third approach can be used when the UE operates in RRC_CONNECTED state in order for the UE to provide assistance information to a serving gNB to determine a NW operation state for use of time/frequency/spatial/power resources.

For supporting the combination, a serving gNB can provide to a UE first PUCCH resources (or PRACH resources), for example according to the first approach and via a SIB, for the UE to transmit a PUCCH with STR for the purpose of “waking-up” the gNB and provide second PUCCH resources or enable use of a MAC CE for the purpose of the UE providing assistance information to the gNB to adjust from a first (non-sleep) NW operation state on a cell to a second (non-sleep) NW operation state on the cell.

In addition to defining a mechanisms and corresponding resources for a UE to provide STR information, corresponding PUCCH transmission occasions (TOs) need to be defined.

In one example, TOs for PUCCH transmissions providing STR information can be linked to PDCCH monitoring occasions associated with DCI format 2_8 as determined by the corresponding search space sets, such as CSS sets. For example, when the PDCCH monitoring occasions occur with a periodicity of P slots, where the slots can be defined for the DL BWP of PDCCH receptions that provide DCI format 2_8 or for a reference DL BWP such as the initial DL BWP where the UE performs initial random access prior to RRC connection, or for a reference/indicated SCS such as 15 kHz, a TO for a PUCCH providing STR information can be defined by a time offset prior to a next PDCCH monitoring occasion for DCI format 2_8.

In that manner, there can be a defined time for the UE to provide STR information, for example via a PUCCH transmission, and the UE to subsequently receive a PDCCH providing a DCI format 2_8 with indication of NW operation states on a cell. Therefore, a TO for PUCCH transmissions with STR can be defined by a time offset relative to a smallest periodicity of PDCCH monitoring occasions providing DCI format 2_8. Also, when DCI format 2_8 is associated with CSS sets, TOs for PUCCH transmissions with STR information can be common for a group of UEs, including all UEs with a same serving gNB, and the time offset can be provided by a SIB. In order to reduce a probability that a serving gNB does not detect a PUCCH transmission with STR information by the UE, or to account for a probability that data arrives at the UE buffer after a first TO, multiple corresponding TOs can be associated with a PDCCH monitoring occasion for DCI format 2_8.

In one example, TOs for PUCCH transmissions providing STR information can be indicated to a UE by UE-specific RRC signaling. Relative to the first approach, a benefit of the second approach, that is applicable in case PUCCH resources for the PUCCH transmissions are UE-specific (can be different among UEs), is that those PUCCH resources can be distributed in time thereby reducing a required PUCCH resource overhead in a particular slot. A drawback is that a time between a TO and a PDCCH monitoring occasion providing DCI format 2_8 can be longer than in the first approach and that gNB energy savings are reduced because the gNB needs to receive PUCCHs providing STR information over multiple TOs for corresponding multiple UEs.

The above mentioned examples for providing TOs for PUCCH transmission can be associated with the approaches used for a PUCCH transmission providing STR information where, for example, the first approach for transmitting a PUCCH with STR can be associated with the first approach for determining a corresponding TO while the second or third approach for transmitting the PUCCH with STR can be associated with the second approach for determining the corresponding TO.

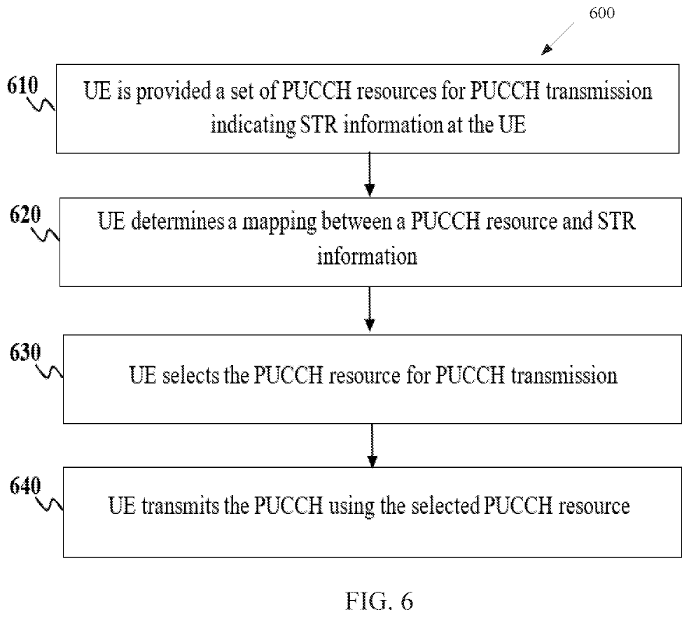

FIG. 6 illustrates a flowchart of UE procedure 600 to select a PUCCH resource and transmit a PUCCH with STR information according to embodiments of the present disclosure. The UE procedure 600 as may be performed by a UE (e.g., 111-116 as illustrated in FIG. 1). An embodiment of the UE procedure 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

A UE is provided a set of PUCCH resources for a PUCCH transmission with STR information 610. A PUCCH resource from the set of PUCCH resources indicates one or more of a NW operation state on a cell, arrival of data at the UE possibly together with an associated latency requirement, a request by the UE to perform measurements such as for handover or for time-frequency synchronization, and so on. The indication of the set of PUCCH resources can be via a SIB or via UE-specific RRC signaling. The UE determines a mapping between a PUCCH resource from the set of PUCCH resources and STR information 620. The UE selects the PUCCH resource for PUCCH transmission 630. The UE transmits the PUCCH using the selected PUCCH resource 640.

After a UE transmits a PUCCH providing STR information, the UE subsequently monitors PDCCH according to indicated search space sets. Prior to monitoring PDCCH for detection of DCI formats scheduling PDSCH receptions or PUSCH transmission, the UE may monitor PDCCH for detection of DCI format 2_8 indicating NW operation states on a cell. The search space sets for subsequent PDCCH monitoring can depend on the indicated NW operation state on the cell. For example, the UE can monitor PDCCH according to a first group or a second group of search space sets if the serving gNB indicates a first or a second NW operation state, respectively, in DCI format 2_8. It is also possible that DCI format 2_8 indicates a series of NW operation states, for example for a gradual transition among active and non-active NW operation states, and the UE monitors PDCCH in a slot according to the valid NW operation state in the slot.

For a set of NW operation states on a cell, a serving gNB can associate indexes of the set of NW operation states on the cell with search space sets that are applicable for the NW operation state on the cell. For example, when the gNB indicates to a UE parameters for a search space set, the parameters can include indexes from the set of NW operation states for which the search space set is applicable. When a NW operation state is valid, the UE monitors PDCCH according to a search space set if the index of the NW operation state is included in the configuration of the search space set; otherwise, the UE does not monitor PDCCH according to the search space set in slots where the NW operation state is valid.

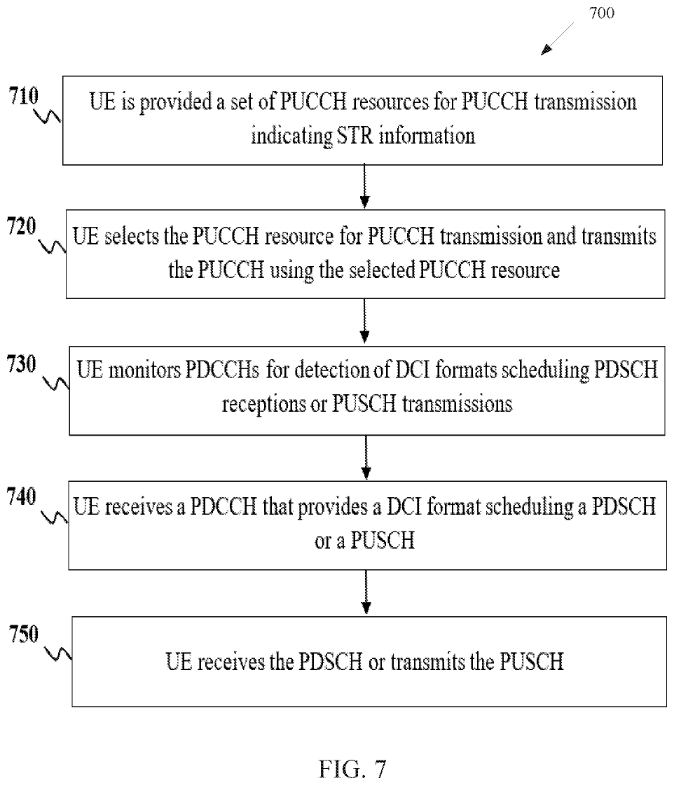

FIG. 7 illustrates a flowchart of UE procedure 700 to transmit a PUCCH indicating STR information and to monitor PDCCH for scheduling PDSCH receptions or PUSCH transmission according to embodiments of the present disclosure. The UE procedure 700 as may be performed by a UE (e.g., 111-116 as illustrated in FIG. 1). An embodiment of the UE procedure 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

A UE is provided a set of PUCCH resources for PUCCH transmission indicating STR information 710. The UE selects the PUCCH resource for PUCCH transmission and transmits the PUCCH using the selected PUCCH resource 720. The UE monitors PDCCHs for detection of DCI formats scheduling PDSCH receptions or PUSCH transmissions 730. The UE receives a PDCCH that provides a DCI format scheduling a PDSCH reception or a PUSCH transmission 740. The UE receives the PDSCH or transmits the PUSCH 750.

After a UE transmits a PUCCH with STR information, the UE can start monitoring a PDCCH for scheduling PDSCH receptions or PUSCH transmissions at a first PDCCH monitoring occasion that is after T₁ slots from the slot of the PUCCH transmission or T₁ slots from the end of the PUCCH transmission or, if the gNB transmits a PDCCH with DCI format 2_8 after TOs for the PUCCH transmission, is after T₁ slots from the slot of the PDCCH reception with DCI format 2_8 or is after T₁ slots from the end of the PDCCH reception with DCI format 2_8. The time offset of T₁ slots can account for a time required by a serving gNB to change a first NW operating state on a cell to a second NW operation state on the cell, including possibly for intermediate NW operation states on the cell, such as for transmitting CSI-RS and receiving CSI reports from UEs or SRS transmissions from UEs, that can apply prior to the second NW operation state on the cell that supports PDCCH transmissions providing DCI formats that schedule PDSCH receptions or PUSCH transmissions. That can help a UE avoid unnecessary PDCCH monitoring according to respective search space sets and reduce associated UE power consumption.

A value of T₁ can be indicated by a SIB or by UE-specific RRC signaling or by MAC CE. A value of T₁ can be same for all NW operation states on a cell or can be separately indicated by higher layer signaling per NW operation state when T₁ is determined relative to a time/slot of the PDCCH reception providing DCI format 2_8 indicating the NW operation state. In such case, T₁ can instead be indicated by DCI format 2_8, either directly in terms of slots or via an index to a set of T₁ values that can be indicated by higher layers or be predetermined in the specifications of the system operation. The value of T₁ can be in units of slots or symbols of the active DL BWP or of a reference SCS, such as 15 kHz or 30 kHz, or can be in absolute time such as in milliseconds.

When a UE monitors a PDCCH for scheduling PDSCH receptions or PUSCH transmissions and after a time interval T₂ from the start of the first PDCCH monitoring occasion the UE has not detected a DCI format that schedules a PDSCH reception or a PUSCH transmission, for example because the serving gNB did not receive the PUCCH with STR information or because the gNB chose to not change a NW operation state on a cell such as a sleep/minimal state, the UE may skip monitoring PDCCH in PDCCH monitoring occasions that occur after T₂. If a serving gNB transmits a PDCCH providing DCI format 2_8 after the TOs of PUCCH transmissions with STR information and the UE does not correctly decode DCI format 2_8, the UE may also skip PDCCH monitoring occasions until a next occurrence of such TOs and reception of a PDCCH that provides DCI format 2_8.

The value of T₂ can be indicated by higher layers, such as a SIB or UE-specific RRC signaling or MAC CE, and can be same for any of the NW operation states on a cell or can be indicated per NW operation state at least when a gNB transmits a PDCCH providing a DCI format 2_8 that indicates a NW operation state after the TOs of PUCCH transmissions with STR information. In such case, T₂ can instead be indicated by DCI format 2_8, either by providing a value of T₂ or by indicating a value of T₂ from a set of values that were provided by higher layer signaling. The value of T₂ can be in same units as the value of T₁. The time interval T₂ can start at the first PDCCH monitoring occasion after the slot of the PUCCH transmission, or after the end of the PUCCH transmission, providing the STR or, if the gNB transmits a PDCCH with DCI format 2_8 after the TOs for the PUCCH, after the slot, or after the end, of the PDCCH transmission.

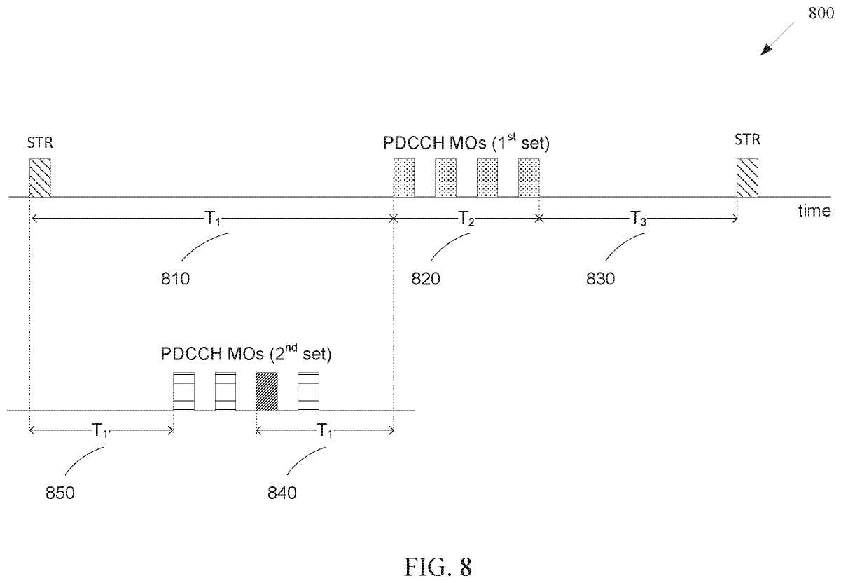

FIG. 8 illustrates example of timing relationships for a PUCCH transmission with STR information and PDCCH monitoring occasions 800 according to this disclosure. An embodiment of the timing relationships for a PUCCH transmission with STR information and PDCCH monitoring occasions 800 shown in FIG. 8 is for illustration only.

T₁ is a time interval from a slot of a PUCCH transmission indicating STR information to a slot where the UE starts monitoring PDCCHs for scheduling PDSCH receptions or PUSCH transmissions 810. T₂ is a time interval from a slot where the UE starts monitoring PDCCHs for scheduling PDSCH receptions or PUSCH transmissions to a slot where the UE stops monitoring PDCCHs after the UE has not detected any DCI format that schedules PDSCH receptions or PUSCH transmissions 820. T₃ is a minimum time interval between a last PDCCH monitoring occasion monitored by the UE after the UE has not detected any DCI format that schedules PDSCH receptions or PUSCH transmissions and a slot where the UE transmits a PUCCH indicating STR information 830.

If the gNB transmits a PDCCH with DCI format 2_8 after a PUCCH reception indicating STR information, a start of PDCCH monitoring for scheduling PDSCH receptions or PUSCH transmissions can be relative to the reception of the PDCCH with DCI format 2_8. Thus, the UE starts monitoring a PDCCH for scheduling PDSCH receptions or PUSCH transmissions after T₁ slots from the slot of the PDCCH reception with DCI format 2_8 840. In case search space sets associated with DCI format 2_8 include multiple PDCCH monitoring occasions, the PDCCH with DCI format 2_8 can be a PDCCH that ends last.

If the gNB transmits a PDCCH with DCI format 2_8 after a PUCCH transmission indicating STR information, T_{1′} is a time interval from a slot of the PUCCH transmission indicating STR information and a slot where the UE starts monitoring PDCCHs for detection of DCI format 2_8 850.

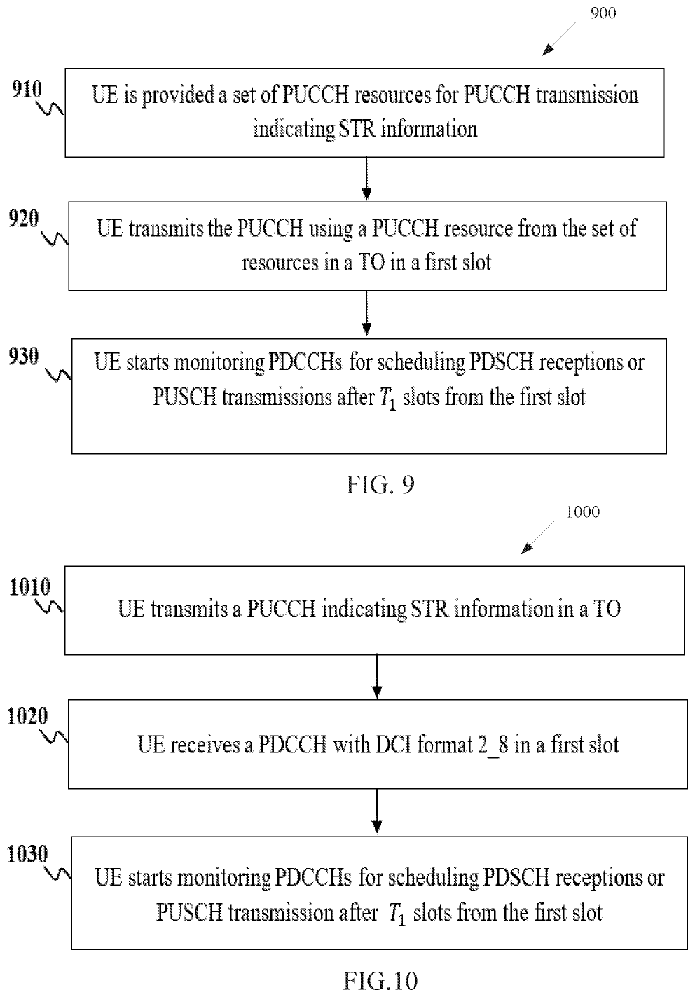

FIG. 9 illustrates a flowchart of UE procedure 900 to start monitoring PDCCHs for scheduling PDSCH receptions or PUSCH transmissions after T_1 slots from a slot of a PUCCH transmission indicating STR information according to embodiments of the present disclosure. The UE procedure 900 as may be performed by a UE (e.g., 111-116 as illustrated in FIG. 1). An embodiment of the UE procedure 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

A UE is provided a set of PUCCH resources for PUCCH transmission indicating STR information 910. The UE transmits the PUCCH using a PUCCH resource from the set of resources in a TO in a first slot 920. The UE can determine the PUCCH resource according to the indicated STR information. The UE starts monitoring PDCCHs for scheduling PDSCH receptions or PUSCH transmissions after T₁ slots from the first slot 930.

FIG. 10 illustrates a flowchart of UE procedure 1000 to start monitoring PDCCHs for scheduling PDSCH receptions or PUSCH transmissions after T_1 slots from a slot of a PDCCH reception with DCI format 2_8 according to embodiments of the present disclosure. The UE procedure 1000 as may be performed by a UE (e.g., 111-116 as illustrated in FIG. 1). An embodiment of the UE procedure 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

A UE transmits a PUCCH indicating STR information in a TO 1010. The UE receives a PDCCH with DCI format 2_8 in a first slot 1020. The UE starts monitoring PDCCHs for scheduling PDSCH receptions or PUSCH transmissions after T₁ slots from the first slot 1030.

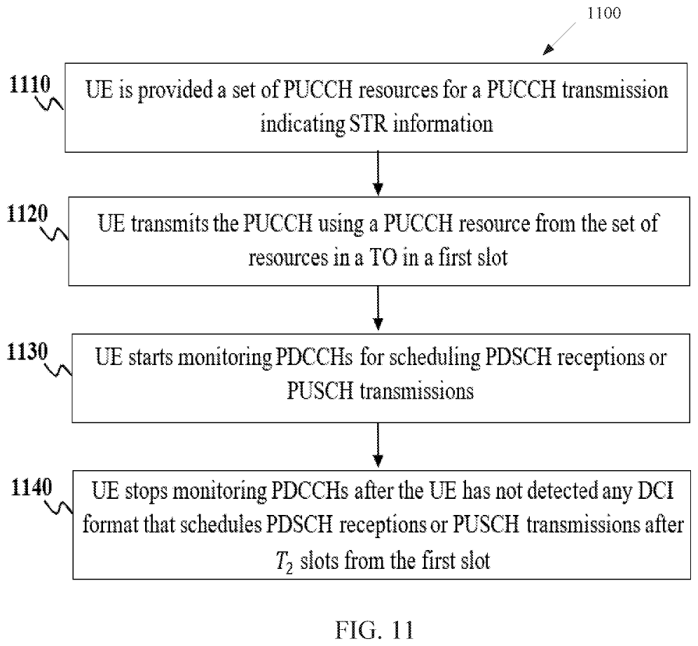

FIG. 11 illustrates a flowchart of UE procedure 1100 to stop monitoring PDCCHs for scheduling PDSCH receptions or PUSCH transmissions (or for DCI format 2_8), after the UE has not detected any DCI format that schedules PDSCH receptions or PUSCH transmissions (or the DCI format 2_8) after T_2 slots from a slot of a PUCCH transmission indicating STR information according to embodiments of the present disclosure. The UE procedure 1100 as may be performed by a UE (e.g., 111-116 as illustrated in FIG. 1). An embodiment of the UE procedure 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

A UE is provided a set of PUCCH resources for a PUCCH transmission indicating STR information 1110. The UE transmits the PUCCH using a PUCCH resource from the set of resources in a TO in a first slot 1120. The UE can determine the PUCCH resource according to the indicated STR information. The UE starts monitoring PDCCHs for scheduling PDSCH receptions or PUSCH transmissions 1130. The UE stops monitoring PDCCHs after the UE has not detected any DCI format that schedules PDSCH receptions or PUSCH transmissions after T₂ slots from the first slot 1140.

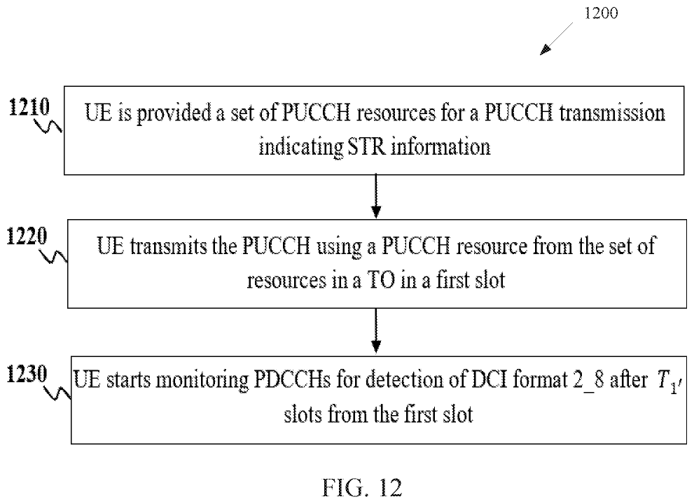

FIG. 12 illustrates a flowchart of UE procedure 1200 to start monitoring PDCCHs for detection of DCI format 2_8 at a first PDCCH monitoring occasion after T_(1\hat{ }′) slots from a slot of a PUCCH transmission indicating STR information according to embodiments of the present disclosure. The UE procedure 1200 as may be performed by a UE (e.g., 111-116 as illustrated in FIG. 1). An embodiment of the UE procedure 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

A UE is provided a set of PUCCH resources for a PUCCH transmission indicating STR information 1210. The UE transmits the PUCCH using a PUCCH resource from the set of resources in a TO in a first slot 1220. The UE starts monitoring PDCCHs for detection of DCI format 2_8 after T_{1′} slots from the first slot 1230.

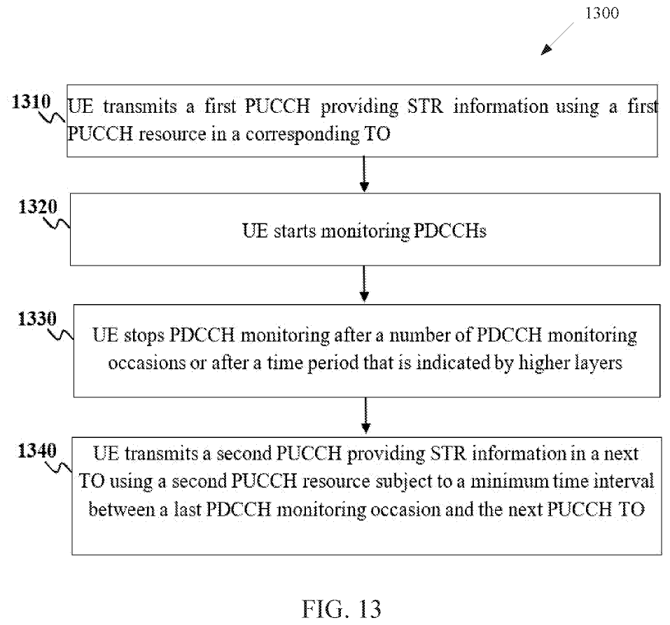

FIG. 13 illustrates a flowchart of UE procedure 1300 to retransmit a PUCCH with STR information and monitor PDCCHs when the UE stops monitoring PDCCHs prior to the PUCCH retransmission according to embodiments of the present disclosure. The UE procedure 1300 as may be performed by a UE (e.g., 111-116 as illustrated in FIG. 1). An embodiment of the UE procedure 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

A UE is provided a set of PUCCH resources for a PUCCH transmission indicating STR information, and transmits a first PUCCH providing STR information using a first PUCCH resource in a corresponding TO 1310. The UE then starts monitoring PDCCHs 1320. The UE stops monitoring PDCCHs after a number of PDCCH monitoring occasions or after a time period that is indicated by higher layers 1330. The UE transmits a second PUCCH providing STR information in a next TO using a second PUCCH resource (that can be same as or different from the first PUCCH resource) subject to a minimum time interval between a last PDCCH monitoring occasion and the next PUCCH TO 1340.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive:
first information for a set of operation states for a cell, and
second information for a set of resources for physical uplink control channel (PUCCH) transmissions; and
a processor operably coupled to the transceiver, the processor configured to determine, at a first time:
first one or more operation states, from the set of operation states, for the cell, and
a resource from the set of resources based on the first one or more operation states for the cell,
wherein the transceiver is further configured to transmit, in response to the determination at the first time, a first PUCCH using the resource.

2. The UE of claim 1, wherein the transmission of the first PUCCH comprises a transmission of an unmodulated sequence.

3. The UE of claim 1, wherein:
the processor is further configured to determine, at a second time, a second operation state for the cell;
the second operation state is same as a current operation state for the cell; and
the transceiver is further configured to skip transmission of a second PUCCH in response to the determination at the second time.

4. The UE of claim 1, wherein elements of the set of operation states for the cell have a one-to-one mapping with elements of the set of resources.

5. The UE of claim 1, wherein the first information and the second information are provided by a system information block (SIB).

6. The UE of claim 1, wherein:
the transceiver is further configured to receive:
third information for search space sets for receiving physical downlink control channels (PDCCHs), and
the PDCCHs,
the PDCCHs are received in response to the transmission of the first PUCCH,
a PDCCH from the PDCCHs provides a downlink control information (DCI) format,
the DCI format indicates an index from a set of indexes, and
elements of the set of indexes have a one-to-one mapping with elements of the set of operation states for the cell.

7. The UE of claim 1, wherein:
the transceiver is further configured to receive:
third information for a time interval,
fourth information for first search space sets for receiving first physical downlink control channels (PDCCHs), and
fifth information for second search space sets for receiving second PDCCHs;
the processor is further configured to determine:
a first earliest reception occasion, after the transmission of the PUCCH, for a reception of the first PDCCHs, and
a second earliest reception occasion, after the first earliest reception occasion, for a reception of the second PDCCHs based on the time interval; and
the transceiver is further configured to receive:
the first PDCCHs at the first earliest reception occasion, wherein a first PDCCH from the first PDCCHs indicates a first operation state from the set of operation states for the cell, and
the second PDCCHs at the second earliest reception occasion, wherein a second PDCCH from the second PDCCHs schedules reception of a physical downlink shared channel (PDSCH) or transmission of a physical uplink shared channel (PUSCH) based on the first operation state.

8. A base station (BS) comprising:
a transceiver configured to transmit:
first information for a set of operation states for a cell, and
second information for a set of resources for physical uplink control channel (PUCCH) receptions; and
a processor operably coupled to the transceiver, the processor configured to determine, at a first time:
first one or more operation states, from the set of operation states, for the cell, and
a resource from the set of resources based on the first one or more operation states for the cell,
wherein the transceiver is further configured to receive, in response to the determination at the first time, a first PUCCH using the resource.

9. The BS of claim 8, wherein the reception of the first PUCCH comprises a reception of an unmodulated sequence.

10. The BS of claim 8, wherein elements of the set of operation states for the cell have a one-to-one mapping with elements of the set of resources.

11. The BS of claim 8, wherein the first information and the second information are provided by a system information block (SIB).

12. The BS of claim 8, wherein:
the transceiver is further configured to transmit:
third information for search space sets for transmitting physical downlink control channels (PDCCHs), and
the PDCCHs,
the PDCCHs are transmitted in response to the reception of the first PUCCH,
a PDCCH from the PDCCHs provides a downlink control information (DCI) format,
the DCI format indicates an index from a set of indexes, and
elements of the set of indexes have a one-to-one mapping with elements of the set of operation states for the cell.

13. The BS of claim 8, wherein:
the transceiver is further configured to transmit:
third information for a time interval,
fourth information for first search space sets for transmitting first physical downlink control channels (PDCCHs), and
fifth information for second search space sets for transmitting second PDCCHs;
the processor is further configured to determine:
a first earliest transmission occasion, after the reception of the PUCCH, for a transmission of the first PDCCHs, and
a second earliest transmission occasion, after the first earliest transmission occasion, for a transmission of the second PDCCHs based on the time interval; and
the transceiver is further configured to transmit:
the first PDCCHs at the first earliest transmission occasion, wherein a first PDCCH from the first PDCCHs indicates a first operation state from the set of operation states for the cell, and
the second PDCCHs at the second earliest transmission occasion, wherein a second PDCCH from the second PDCCHs schedules transmission of a physical downlink shared channel (PDSCH) or reception of a physical uplink shared channel (PUSCH) based on the first operation state.

14. A method comprising:
receiving:
first information for a set of operation states for a cell, and
second information for a set of resources for physical uplink control channel (PUCCH) transmissions;
determining, at a first time:
first one or more operation states, from the set of operation states, for the cell, and
a resource from the set of resources based on the first one or more operation states for the cell; and
transmitting, in response to the determination at the first time, a first PUCCH using the resource.

15. The method of claim 14, wherein the transmission of the PUCCH comprises a transmission of an unmodulated sequence.

16. The method of claim 14, further comprising:
determining, at a second time, a second operation state for the cell, wherein the second operation state is same as a current operation state for the cell; and
skipping transmission of a second PUCCH in response to the determination at the second time.

17. The method of claim 14, wherein elements of the set of operation states for the cell have a one-to-one mapping with elements of the set of resources.

18. The method of claim 14, wherein the first information and the second information are provided by a system information block (SIB).

19. The method of claim 14, further comprising:
receiving:
third information for search space sets for receiving physical downlink control channels (PDCCHs), and
the PDCCHs,
wherein the PDCCHs are received in response to the transmission of the PUCCH,
wherein a PDCCH from the PDCCHs provides a downlink control information (DCI) format,
wherein the DCI format indicates an index from a set of indexes, and
wherein elements of the set of indexes have a one-to-one mapping with elements of the set of operation states for the cell.

20. The method of claim 14, further comprising:
receiving:
third information for a time interval,
fourth information for first search space sets for receiving first physical downlink control channels (PDCCHs), and
fifth information for second search space sets for receiving second PDCCHs;
determining:
a first earliest reception occasion, after the transmission of the PUCCH, for a reception of the first PDCCHs, and
a second earliest reception occasion, after the first earliest reception occasion, for a reception of the second PDCCHs based on the time interval; and
receiving:
the first PDCCHs at the first earliest reception occasion, wherein a first PDCCH from the first PDCCHs indicates a first operation state from the set of operation states for the cell, and
the second PDCCHs at the second earliest reception occasion, wherein a second PDCCH from the second PDCCHs schedules reception of a physical downlink shared channel (PDSCH) or transmission of a physical uplink shared channel (PUSCH) based on the first operation state.
